(19) United States
(12) Patent Application Publication
(10) Pub. No.: US 2008/0105737 A1
(43) Pub. Date: May 8, 2008

(54) User programmable fix transactions

(75) Inventor: Georges Gomes, Issy Les Moulineaux (FR)

Correspondence Address: David Aker, 23 Southern Road, Hartsdale, NY, 10530, US

(73) Assignee: Ullink Inc.

(21) Appl. No.: 11/592,648

(22) Filed: Nov. 2, 2006

(51) Int. Cl. G06F 17/00; G06K 19/06

(52) U.S. Cl. 235/375; 235/494

(57) ABSTRACT

A storage medium having computer readable code for configuring a computer code object to conduct financial transactions using the financial information exchange protocol, comprising computer readable code for generating a graphical user interface for assisting a user in providing input indicative of rules of engagement to be used in conducting the transactions in the financial information exchange protocol; and computer readable code for translating the input into program logic of the computer code object so that the object is usable for conducting the transactions using the financial information exchange protocol. Computer code facilitates documentation of a configuration of the rules of engagement programmed into the object by the input, and facilitates storage, as a template, of a configuration of the rules of engagement programmed into the object. A computer system and a method, for conducting transactions in accordance with the computer code. A computer platform to which the programmed object may be transferred to conduct transactions.

### BACKGROUND OF THE INVENTION

1. Field of the Invention

The present invention relates to apparatus, methods, and software used in financial transactions. More particularly, it relates to apparatus, methods and software for use with the so called Financial Information exchange (FIX) format, a financial industry standard for electronic trading communication.

2. Background Art

Generally, there have been a variety of techniques and message format used for financial transactions. Perhaps the most ubiquitous is the FIX format. Various versions of this format have been used, and various companies (for example, Ullink, of Paris, France; www.ullink.com) supply so called FIX engines, which run on personal computers to allow the exchange of information needed for financial transactions.

The configuration of software to define so called “rules of engagement” for the manner in which a financial transaction using the FIX format is to occur, has not been easily accomplished. It is further complicated by the various available versions of FIX. Generally, it has been necessary to reprogram the software, utilizing the services of a skilled programmer and requires that source code be modified, tested, debugged, tested again, and finally certified as being acceptable. Users, having systems which are operating well, are notoriously cautious and generally very resistant to making changes in properly operating software upon which they depend for the smooth and successful operation of their business systems.

### SUMMARY OF THE INVENTION

It is an object of the invention to provide a protocol normalization engine that operates in accordance with rules easily programmed into a program object.

It is a further object of the invention to provide a configuration front-end accessible from most Internet browsers.

It is an additional object of the invention to provide the user with choice of supported message types, possible tags for each message type and possible values for each tag.

It is another object of the invention to provide an expression language to implement smart processing of messages.

It is a yet another object of the invention to provide the user with a list of template configurations for most versions of the FIX protocol.

It is still another object of the invention to be able to automatically generate a specification document of a configured Plug-in.

It is yet an additional object of the invention to be able to recall previous configuration via an archiving mechanism.

In accordance with the invention, to define the rules of engagement for a FIX session, the plug in is programmed by answering some simple questions, and checking off appropriate check boxes, quickly and easily, with simple screens presented to the user. Fields are provided on certain screens for adding custom user input, also in a quick and simple manner. The user inputs are translated into program logic in a program object that may be exported to or configured on an appropriate platform for conducting transactions.

Thus, it is very easy to do the programming, or to change it. There is a back-up version of the rules of engagement (a template) or a previous version of the rules that can be selected, and then easily modified, to change the rules for a different session.

These objects and others are achieved in accordance with the invention by a storage medium having computer readable code thereon for configuring a computer code object to conduct financial transactions using the financial information exchange protocol. The code comprises computer readable code for generating a graphical user interface for assisting a user in providing input indicative of rules of engagement to be used in conducting the transactions in the financial information exchange protocol; and computer readable code for translating the input into program logic of the computer code object so that the object is usable for conducting the transactions using the financial information exchange protocol.

The storage graphical user interface comprises a series of screens displayed to a user. Preferably, the storage medium further comprises computer code for facilitating documentation of a configuration of the rules of engagement programmed into the object by the input. The storage medium may further comprise computer code for facilitating storage, as a template, of a configuration of the rules of engagement programmed into the object.

The computer readable code may cause the graphical user interface to be displayed on a browser of a personal computer. It may also further comprise code for exporting the computer code object to a platform on which the object is used to conduct the transactions.

The computer code includes code for causing the graphical user interface to be configured to accept input including a) what version of the financial information exchange protocol is to be used for a session; b) which messages are to be supported by the session; c) whether custom tags in the messages are to be supported; and d) possible values for each tag.

The computer code for the object includes code for causing the object to perform the functions of parsing financial transaction messages, checking tags of the messages, validating grammar of the messages, and normalizing the messages.

The storage medium is utilized in combination with a computer system, wherein the computer system comprises means for reading the computer readable code so as to generate the graphical user interface; and input means for providing the input to the computer via the graphical user interface. Preferably, the computer system further comprises means for exporting the object to another computer system, so that the transactions are conducted on the another computer system.

The invention is also directed to a method for programming a digital computer to perform transactions using the financial information exchange protocol, comprising programming the computer by reading program code from the medium described above; and using the program code object, after the input has been translated into program logic of the computer code object, to perform the transactions.

Preferably, the method further comprises documenting a configuration of the rules of engagement programmed in the object by the input. The method may further comprise storing a configuration of the rules of engagement programmed in the object by the input.

The invention is further directed to a method for programming a digital computer to perform transactions using the financial information exchange protocol, comprising programming the computer by reading program code from the medium as described above; transferring the object to another computer after the input has been translated into program logic of the computer code object; and using the program code object on the another computer to perform the transactions.

Preferably, the method further comprises documenting a configuration of the rules of engagement programmed in the object by the input. The method may further comprise storing a configuration of the rules of engagement programmed in the object by the input.

In accordance with another aspect, the invention is directed to a computer system for conducting financial transactions using the financial information exchange protocol, comprising a computer programmed with computer code for generating a graphical user interface for assisting a user in providing input indicative of rules of engagement to be used in conducting the transactions in the financial information exchange protocol; and for translating the input into program logic of a program object usable for conducting the transactions using the financial information exchange protocol.

The graphical user interface comprises a series of screens displayed to a user. The computer system is further programmed with computer code for facilitating documentation of a configuration of the rules of engagement programmed into the program object by the input.

Preferably, the computer system is further programmed with computer code for facilitating storage, as a template, of a configuration of the rules of engagement programmed into the object.

The computer code may cause the graphical user interface to be displayed on a browser of a personal computer.

The computer system may be further programmed with computer code for exporting the object to a computer platform on which the object is used to conduct the transactions.

The invention is also directed to the computer system, in combination with the computer platform. The platform may comprise a server for connection to a wide area computer network; and middleware running on the server to facilitate communication of messages to and from users of the computer system. Preferably, the middleware includes a software engine for facilitating the transactions using the financial information exchange protocol.

The computer system preferably includes computer code which further comprises code for causing the graphical user interface to be configured to accept input including a) what version of the financial information exchange protocol is to be used for a session; b) which messages are to be supported by the session; c) whether custom tags in the messages are to be supported; and d) possible values for each tag.

The computer code of the object may include code for causing the object to perform the functions of parsing financial transaction messages, checking tags of the messages, validating grammar of the messages, and normalizing the messages.

The computer may comprise means for reading the computer readable code so as to generate the graphical user interface; and input means for providing the input to the computer via the graphical user interface.

### BRIEF DESCRIPTION OF THE DRAWINGS

The foregoing aspects and other features of the present invention are explained in the following description, taken in connection with the accompanying drawings, wherein:

FIG. 1 is a very high level diagram illustrating the interconnection of personal computers via the Internet or private network, using a software Bridge in accordance with the prior art.

FIG. 2 is a flow chart of the message processing in a system in accordance with the invention.

FIG. 3 is a capture of a screen presenting configurable message types, and allowing dynamic selection of which FIX message types are supported by the adapter in accordance with the invention.

FIG. 4 is a capture of a screen presenting a list of tags and custom tags additions.

FIG. 5 is a capture of a screen presenting tags definition and validity domain for each message type supported by the system of the invention.

### DETAILED DESCRIPTION OF THE PREFERRED EMBODIMENT

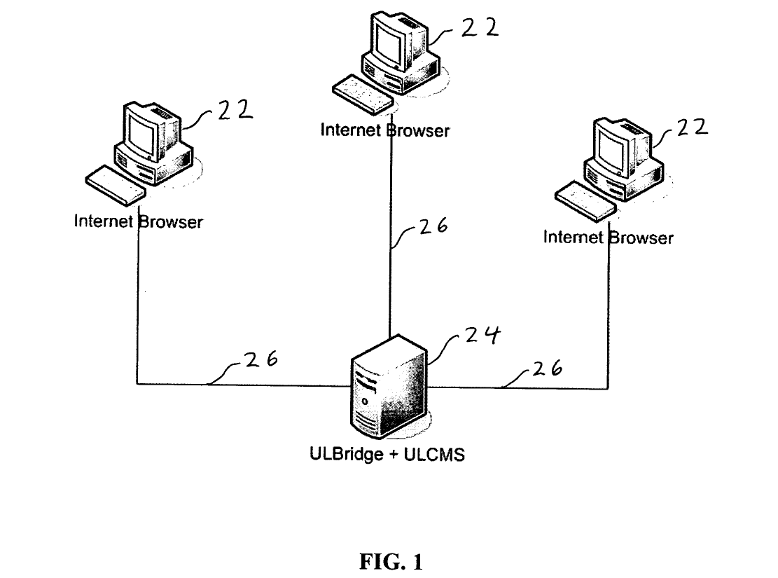

Referring to FIG. 1, there is shown a high-level system diagram of a system 20 incorporating features of the present invention. Although the present invention will be described with reference to the embodiment shown in the drawings, it should be understood that the present invention can be embodied in many alternate forms of embodiments. In addition, any suitable type of elements or components can be used.

In FIG. 1, system 20 includes a number of personal computers 22, each having an Internet browser, such as Internet Explorer 6.0, a well known product of Microsoft Corporation. Computers 22 are connected by a suitable network connections, such as an Ethernet® connection or a comparable wireless connection (not shown) to server 24 which performs the function of connection to a very wide area network, such as a virtual private network or the Internet by means of a preferably broad band connections 26.

Server 24 has running on it transactional middleware, called ULBridge (available from Ullink, of Paris, France; www.ullink.com) that enables financial institutions to connect trading applications in various execution venues via FIX and other formats. In general, the middleware of the ULBridge supports multiple message types, multiple message formats, all asset classes, is highly scalable, supports client defined order routing rules, allows for message tracking and monitoring, and for message enrichment. ULBridge middleware operates using the ULBridge Expression Language to propose a simple syntax for the representation of the Expressions used by the ULBridge and its adapters and modules to perform many tasks. Expressions written in the ULBridge Expression Language are evaluated by the ULBridge adapters at runtime against incoming messages. The ULBridge Expression Language is described in the Appendix herein.

In accordance with the invention, the ULBridge can be configured with a Connectivity Management System (CMS), which is a plug-in or adapter that is FIX-based, with two possible kinds of FIX transport: FIX over TCP and FIX over Tibco Rendez-Vous. CMS adapters can be sell-side adapters (i.e. adapters collecting client orders and routing them through the ULBridge) or buy-side adapters (i.e. adapters sending orders to an exchange or a source or liquidity).

The CMS has a CMS Web Interface, which is a web-based configuration and management interface for the CMS. The CMS Web Interface is layered on top of the HTTP protocol, thus enabling a Graphical User Interface (GUI) to run in a web browser of, for example, one of the computers 22. The server part of the CMS is run by the ULBridge itself.

The CMS Web Interface provides the following features:

### Dynamic management and configuration of the CMS adapters.

### Configuration of the Global CMS Settings.

Integrated Documentation Generator. Integrated backup management system for CMS adapters.

The layout of the pages used to manage the Global CMS Settings is the same as in all the ULRemote Web Interface pages, except that a CMS specific header is displayed at the top of the page. The menu displayed at the left of the pages is different from the menu in the ULRemote Web Interface. Below is a description of the items in the menu:

1. A facility for access to the page used to manage the Global CMS Vocabulary.

2. A facility for access to the page used to manage the CMS Configuration Templates.

3. A facility for taking the user back to the home page of the ULRemote Web Interface.

A new CMS Configuration Template can be registered. At the top of the page, a hyperlink provides access to the page where a new CMS Configuration Template can be registered into the CMS. This page contains the following elements:

A. Text field Path is used to enter the path, on the local file-system, of the CMS Configuration file (with a .cfb extension), which needs to be registered as a new CMS Configuration Template.

B. A Button labeled Create submits the registration request and takes the user back to the page displaying the list of CMS Configuration Templates.

C. A button labeled Cancel cancels the registration and takes the user back to the page displaying the list of CMS Configuration Templates.

Once a new CMS Configuration Template has been registered, it becomes automatically available to configure all CMS adapters in the ULBridge.

In the list of CMS Configuration Templates, any number of CMS Configuration Templates can be selected for deletion by checking the box displayed at the right of each line. Then, the icon at the top of the table can be used to delete the selected elements from the list. Removing a CMS configuration template does not impact the CMS adapters which may have been configured with this CMS Configuration Template. Once the changes in the CMS configuration of an adapter are committed, the CMS configuration is owned by the adapter, with no dependency on the CMS Configuration Template.

A General Settings page contains the following input fields:

A. FIX Version is a drop-down list from which the version of the FIX protocol used by the CMS adapter can be chosen. This FIX version is exchanged in all FIX messages in tag BeginString (8).
B. Input fields SenderCompID and TargetCompID are used to enter the SenderCompID and TargetCompID values used by the CMS adapter in all FIX messages. In addition to sending those values in all FIX messages (in FIX tags SenderCompID (49) and TargetCompID (56) respectively), the CMS adapter always checks the SenderCompID and TargetCompID sent by its FIX counterpart. The values specified for SenderCompID and TargetCompID in this page can be overridden by configuration, using entries SenderCompID and TargetCompID in the “session” section of the adapter's initialization file. Using the initialization file to override the SenderCompID and TargetCompID can be useful during a deployment phase. In addition, this makes the initialization files of CMS adapters more homogeneous with the initialization files of other types of adapters.
C. Checkboxes with label Unsolicited Execution Reports are used to control the behavior of the CMS adapter when an unsolicited execution report is received. These checkboxes are displayed in this page only if the CMS adapter is a sell-side adapter. If a checkbox with label Ignore (unsolicited ‘cancel’ execution reports) is checked, then all unsolicited execution reports where the value in ULMessage tag ORDSTATUS is either pending/cancel or cancel are discarded.

### D. If a checkbox with label Ignore unsolicited ‘replace’ execution reports is checked, then all unsolicited execution reports where the value in ULMessage tag ORDSTATUS is either pending/replace or replace are discarded.

E. A Checkbox with label Generation of pending new messages (sell-side adapters only) is used to instruct this adapter to automatically send out a pending new execution report back to its FIX counterpart upon reception of a new single order. This is not a standard FIX kinematics, and the generation of pending new execution reports should therefore be activated only in cases where this explicitly requested by the counterpart.
F. Checkboxes with label Generation of pending messages (buy-side adapters only) are used to instruct the adapter to automatically route an execution report type pending cancel or pending replace through the ULBridge uponreception of an order cancel request or an order replace request, respectively.

### G. If a checkbox with label Generate pending cancel execution reports is checked, then an execution report type pending cancel is automatically routed through the ULBridge when an order cancel request is received by the adapter.

### H. If a checkbox with label Generate pending replace execution reports is checked, then an execution report type pending replace is automatically routed through the ULBridge when an order cancel request is received by the adapter.

The generation of pending message upon reception of order cancel requests or order replace requests is a standardFIX kinematics, and these options are useful in cases where the FIX counterpart does not send these messages itself.

I. A Checkbox with label Verbose mode can be checked in order to instruct the CMS adapter to print a trace (with the debug level) into the ULBridge logs for each individual action it takes during the processing of a message (validation of the message type and grammar, normalization, message filtering, etc.). This option can be very useful to diagnose the behavior of the CMS adapter when a message is not processed in the way it should be. However, since tens of lines of logs are printed each time a message is processed, this option should never be activated in a production environment. A text area with label Description can be used to enter a textual description of the CMS configuration which is being edited. This description can be useful to keep track of important changes in the configuration.
J. At the bottom, the Change button must be clicked in order to validate the changes in the configuration. Clicking the Change button does not propagate the changes to the CMS adapter. The only way to have the CMS adapter take the changes into account is to use the Commit action.

### Configuration Page.

The history of changes in the configuration. At the bottom of the page, a table displays the history of changes in the CMS configuration of the adapter. This table has three columns and contains one line for each commit which has be performed on this adapter:

### 1. Column Date displays the date of the commit.

### 2. Column Owner displays the name of the user who has performed the commit.

### 3. Column Comments displays the comments which have been entered during the commit.

In accordance with the invention, the adapter may be modeled, tested, and documented from one of the browsers in one of computers 22, and then used within the ULBRIDGE to “go live” and conduct actual business transactions.

In order to provide support for these different categories of adapters, the CMS comes with four generic Java classes which can used to create new instances of CMS adapters.

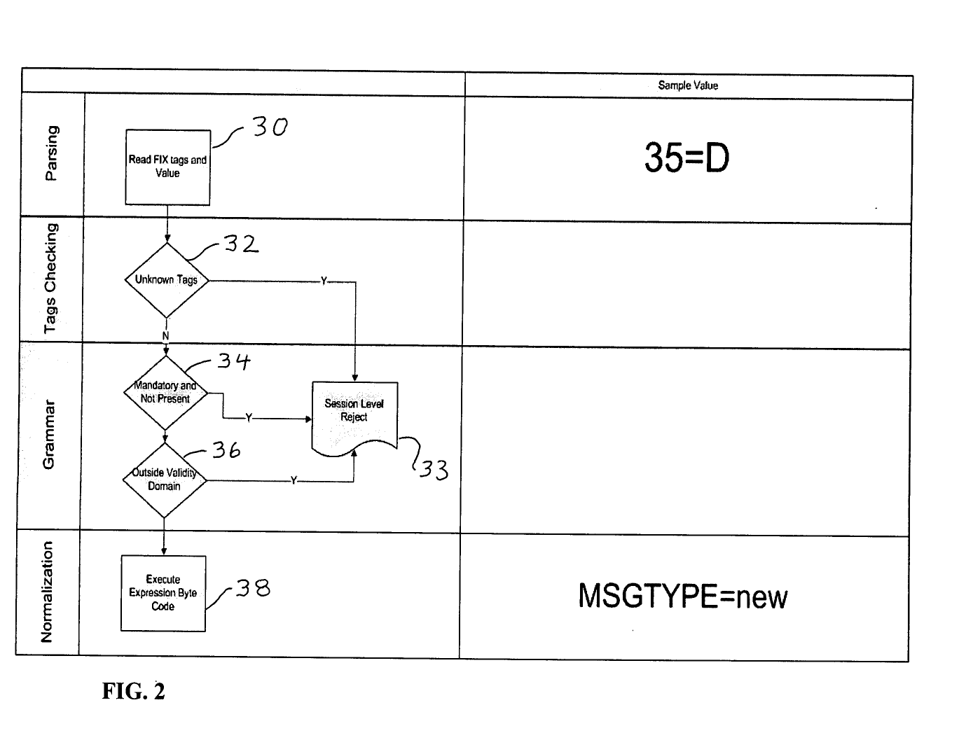

Referring to FIG. 2, Message processing is articulated around four distinct sub-routines:

### 1) Message Parsing

This is the process of validating the inbound FIX message and separating tag numbers from values. At this stage, on FIX session level rules are taken under consideration. The fix tags are read and their values are read at step 30.

### 2) Tags Checking

Each plug-ins defines its own vocabulary, which is a list of all know tags by this interface. This processing, at 32, checks that all tags in this incoming message are indeed known by the plug-in. If not know, the message undergoes a session level reject at 33. This is mostly used for filtering out unknown FIX messages. Declaring the list of tags known by the plug-in is part of the invention.

### 3) Grammar Validation

This subroutine allows controlling the validity of a specific tag. This check applies to every single tag in every single message type. For every message type supported by the plug-in, each tag can be flagged as mandatory at 34. A regular expression can be provided to restrict the validity domain of possible tag values at 36. When a message successfully clears the grammar check, it is properly formatted. If it does not clear the checks at 34 and 36, the message undergoes a session level reject at 33.

### 4) Normalization

This is the process of building a valid ULMessage from FIX data. Each tag can be assigned a static or dynamic value. The dynamic value is assigned by evaluating the compiled version (byte code) of an expression language. The expression language, detailed in Appendix A, can be used to invoke functions, lookup values in table, read data from the ULBridge database. The expression byte code is executed at 38.

The entire plug-in behavior (mapping, constraints and logic) is represented in memory as an object. This object can be serialized into an XML data structure. This XML data constitutes the plug-in configuration file, stored as .cfb file. The format of this .cfb file is as follows:

### Example of Plug-In Revisions:

```
<history>
    <version date=“2005-02-17 16:07:42” owner=“admin” />
    <version date=“2005-02-17 16:17:20”
owner=“admin”>completing tag
  normalization for order cancel request</version>
</history>
```

### Example of Supported Message Types and Description:

```
<message-types>
    <message-type value=“G” description=“Order
Cancel/Replace Request” rejection=“Message type G (Order
Cancel/Replace Request) is not supported by this adapter”
supported=“true” />
    <message-type value=“H” description=“Order Status
Request” rejection=“Message type H (Order Status Request)
is not supported by this adapter” supported=“true” />
<message-types>
```

### Example of FIX Vocabulary Definition:

```
<vocabulary>
    <vocabulary-tag name=“1” alt=“Account” type=“string”
read-only=“false”>
    <description>1. Account mnemonic as agreed between
broker and institution.</description>
    </vocabulary-tag>
    <vocabulary-tag name=“2” alt=“AdvId” type=“integer”
read-only=“false”>
    <description>2. Unique identifier of advertisement
message</description>
    </vocabulary-tag>
</ vocabulary>
```

### Tag Constraint Example:

<tag-constraint name=“18” activated=“true” read-
only=“false” part=“body” required=“false”>
<string-validity regexp=“\hat{ }[1234567890ABCDEFGILMN
OPRS]( [1234567890ABCDEFGILMNOPRS])*$” domain=“ranges” />
</tag-constraint>

### Conditional Tag With Expression Evaluation Example:

```
<tag-constraint name=“6” activated=“true” read-
only=“false” part=“body” required=“true”>
    <condition>
    <expression value=“$136 &gt; 0”
type=“com.ullink.ulbridge2.toolkit.plugins.fix.model.state.-
mapping.FIXMessageExpression”>
    <comparison-operator
type=“com.ullink.ulbridge2.expression.Gt” label=“&gt;”
brackets=“false”>
    <operand>
        <tag label=“136”
type=“com.ullink.ulbridge2.expression.IntegerVar”
brackets=“false”
/>
    </operand>
    <operand>
    <value label=“0”
type=“com.ullink.ulbridge2.expression.IntegerValue”
brackets=“false” />
    </operand>
    </comparison-operator>
    </expression>
    </condition>
        <float-validity domain=“all-values”>
            <float-range min=“minimum” max=“maximum”
/>
        </float-validity>
        </tag-constraint>
```

In accordance with the invention, to define the rules of engagement for a FIX session, the plug in is programmed by answering the following questions 1-5, quickly and easily, with simple screens presented to the user.

### 1. What version of FIX protocol is to be used for the session (FIX 4.0, 4.1, 4.2, 4.3 or 4.4).

### 2. Which messages are supported by the session? (There are 20-30 types, the user can check the off from a list; 5 or 6 may be default choices, and the user can choose to add or delete.)

3. Are there any custom tags in the message? Tags are identified by a unique number (e.g. Message type is tag 35 (FIG. 2). The users can extend the FIX protocol by creating their own tag. These tags are typically used to store additional information not already available in the list of standard FIX tags.
4. What are the possible values for each tag (which ones are supported?)? For example, tag 21 can have values of 1, 2 and 3. Particular sessions can support 1 or more values. The protocol can be extended to support other or additional values for a tag (by use of an add screen in “regular expression” language, which is well know in UNIX and is used for scripting.).

### 5. Which tags are supported in which message? This can change form one user to another.

After the Programming is Accomplished:

6. Rules of engagement are documents defining the supported messages, tags and their values within a specific FIX session. These rules can be used to program a plug-in or any other form of FIX engine. In other words a user reference for the session is generated.

From an implementation standpoint, CMS leverages several open source libraries mostly from the Apache Software Foundation. All CMS logic is stored in XML format. The XML is generated and manipulated using DOM capabilities of Xerces (http://xerces.apache.org/xerces-j/). Every property of the FIX session that is represented in the GUI, ends up in the XML tree. The Rules of Engagement PDF document is generated dynamically using a combination of batik (http://xmlgraphics.apache.org/batik/) and fop (http://xmlgraphics.apache.org/fop/). These two libraries support, respectively, the generation of an SVG document and its conversion into PDF format. The Application Server component used to serve user HTML pages leverages a ULBridge instance of Jetty (http://jetty.mortbay.org/).

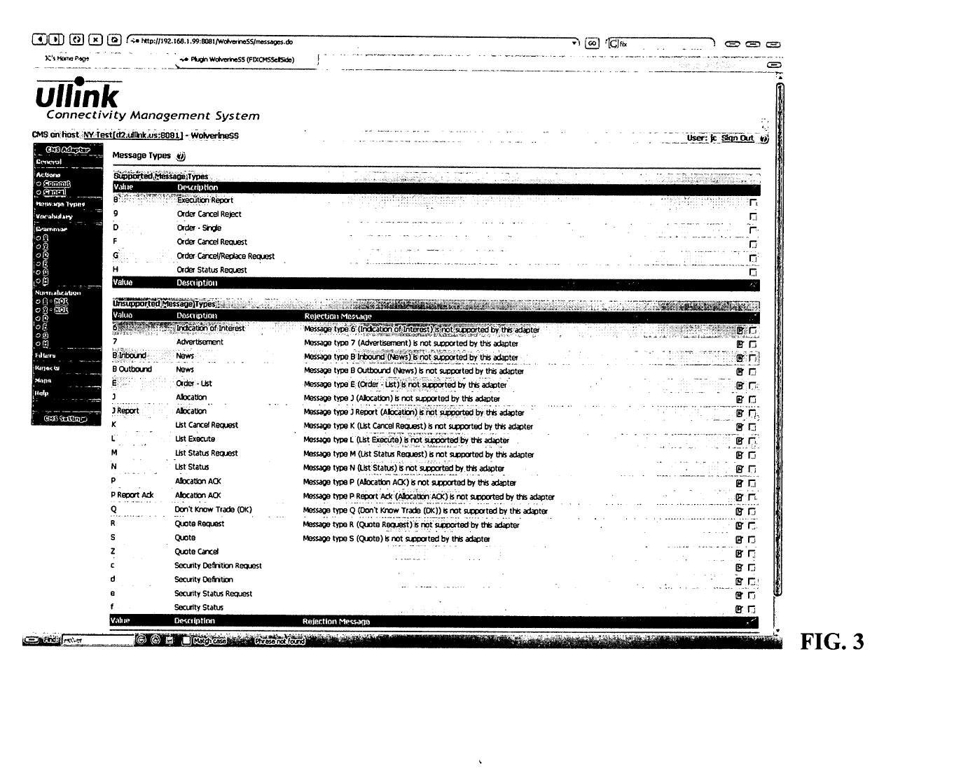

FIG. 3 is a capture of a screen presenting configurable message types, and allowing dynamic selection of which FIX message types are supported by the adapter in accordance with the invention. The message types listed on this screen are standard FIX values and designation. Both supported and unsupported message types are displayed. The user merely needs to check off which types of messages should be in which portion of the screen, by using conventional means for providing input to a graphical user interface, such as by placing a cursor at the proper selection box with a mouse, track ball or other similar input device, and by clicking the proper mouse button.

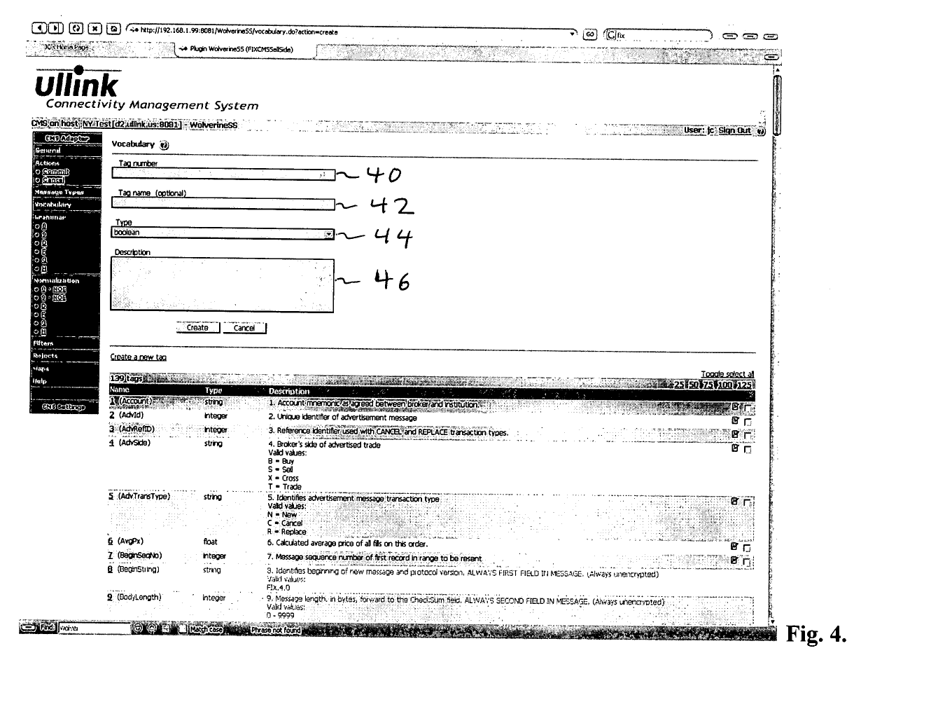

FIG. 4 is a capture of a screen presenting a list of tags and custom tags additions. The ability to create or to cancel tags is provided by typing the information into the indicated fields, which are tag number 40, tag name 42, which is optional, tag type 44 and a description 46. A custom tag is created by entering a unique Tag Number, an optional Tag Name, a Tag Type (one of Boolean, Integer, Float, Char, String, Timestamp) and an optional Tag Description in these fields, respectively. All tags in this list can be removed at any time by checking the selection checkbox and pressing or clicking on the red arrow in the header.

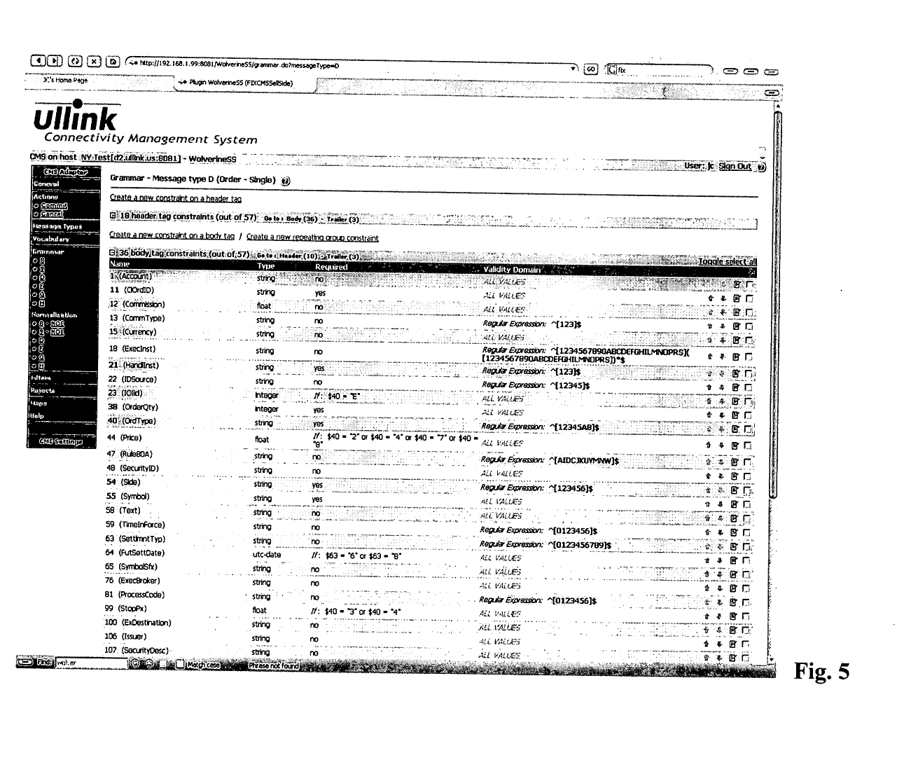

FIG. 5 is a capture of a screen presenting tags definition and validity domain for each message type supported by the system of the invention. Although FIX clearly defines which Tags are supported for which Message Types and their possible value, real life implementation of the protocol requires flexibility. This screens allows control of which tags, defined in the plug-in vocabulary (see above), can be used in each Message Type. Along with the list of supported Tags, the user configures specific attributes for each Tag such as requirements. A given Tag can be one of required, conditionally required or not required. In the case of a conditionally required tag, the condition can be expressed using the ULBridge Expression Language, which makes this condition dynamic—in other words, evaluated during runtime—. In addition to the requirement, the user can specify the validity domain for Tag values. This validity domain is expressed using the “regular expression” mechanism. Basically, the regular expression is a string describing a pattern that the Tag value must match. If during runtime the Tag value does not satisfy that validity constraint, the incoming message would be rejected.

FIG. 5. shows the list of supported Tags and associated attributes for Message Type D. Similar configuration can be done for all Message Types supported by this plug-in.

It will be understood that additional screens are provided for additional functions. For example, a documentation screen can be provided to allow the user to choose between generating a PDF or an HTML version of a configuration which is to be documented so as to provide a record of the configuration, and thus the rules of engagement that were used for a give transaction session. The documentation screen can also allow the user to choose between full documentation of the configuration of the adaptor or programming object, or documentation of changes with respect to a prior documented configuration.

As another example, a screen may be provided with a drop down menu for selecting a template representing a prior configuration. Each such template can have associated with it a complete path to the storage location of the template to facilitate its recall and use.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A storage medium having computer readable code thereon for configuring a computer code object to conduct financial transactions using the financial information exchange protocol, comprising:
computer readable code for generating a graphical user interface for assisting a user in providing input indicative of rules of engagement to be used in conducting the transactions in the financial information exchange protocol; and
computer readable code for translating the input into program logic of said computer code object so that said object is usable for conducting said transactions using the financial information exchange protocol.

2. The storage medium of claim 1, wherein the graphical user interface comprises a series of screens displayed to a user.

3. The storage medium of claim 1, further comprising computer code for facilitating documentation of a configuration of said rules of engagement programmed into said object by said input.

4. The storage medium of claim 1, further comprising computer code for facilitating storage, as a template, of a configuration of said rules of engagement programmed into said object.

5. The storage medium of claim 1, wherein the computer readable code causes said graphical user interface to be displayed on a browser of a personal computer.

6. The storage medium of claim 1, further comprising code for exporting said computer code object to a platform on which said object is used to conduct said transactions.

7. The storage medium of claim 1, wherein said computer code includes code for causing said graphical user interface to be configured to accept input including:
a) what version of the financial information exchange protocol is to be used for a session;
b) which messages are to be supported by the session;
c) whether custom tags in the messages are to be supported; and
d) possible values for each tag.

8. The storage medium of claim 1, wherein computer code for said object includes code for causing said object to perform the functions of parsing financial transaction messages, checking tags of said messages, validating grammar of said messages, and normalizing said messages.

9. The storage medium of claim 1, in combination with a computer system, the computer system comprising;
means for reading said computer readable code so as to generate said graphical user interface; and
input means for providing said input to said computer via said graphical user interface.

10. The combination of claim 9, wherein said computer further comprises means for exporting said object to another computer system, so that said transactions are conducted on said another computer system.

11. A method for programming a digital computer to perform transactions using the financial information exchange protocol, comprising:
programming the computer by reading program code from the medium of claim 1; and
using the program code object, after the input has been translated into program logic of said computer code object, to perform said transactions.

12. The method of claim 11, further comprising documenting a configuration of said rules of engagement programmed in said object by said input.

13. The method of claim 11, further comprising storing a configuration of said rules of engagement programmed in said object by said input.

14. A method for programming a digital computer to perform transactions using the financial information exchange protocol, comprising:
programming the computer by reading program code from the medium of claim 1;
transferring the object to another computer after the input has been translated into program logic of said computer code object; and
using the program code object on said another computer to perform said transactions.

15. The method of claim 14, further comprising documenting a configuration of said rules of engagement programmed in said object by said input.

16. The method of claim 14, further comprising storing a configuration of said rules of engagement programmed in said object by said input.

17. A computer system for conducting financial transactions using the financial information exchange protocol, comprising:
a computer programmed with computer code for: generating a graphical user interface for assisting a user in providing input indicative of rules of engagement to be used in conducting the transactions in the financial information exchange protocol; and for translating the input into program logic of a program object usable for conducting said transactions using the financial information exchange protocol.

18. The computer system of claim 17, wherein the graphical user interface comprises a series of screens displayed to a user.

19. The computer system of claim 17, wherein said computer is further programmed with computer code for facilitating documentation of a configuration of said rules of engagement programmed into said program object by said input.

20. The computer system of claim 17, wherein said computer is further programmed with computer code for facilitating storage, as a template, of a configuration of said rules of engagement programmed into said object.

21. The computer system of claim 17, wherein the computer code causes said graphical user interface to be displayed on a browser of a personal computer.

22. The computer system of claim 17, wherein said computer is further programmed with computer code for exporting said object to a computer platform on which said object is used to conduct said transactions.

23. The computer system of claim 22, in combination with said computer platform.

24. The combination of claim 23, wherein said platform comprises:
a server for connection to a wide area computer network; and
middleware running on said server to facilitate communication of messages to and from users of said computer system.

25. The combination of claim 24, wherein said middleware includes a software engine for facilitating said transactions using the financial information exchange protocol.

26. The computer system of claim 17, wherein said computer code further comprises code for causing said graphical user interface to be configured to accept input including:
a) what version of the financial information exchange protocol is to be used for a session;
b) which messages are to be supported by the session;
c) whether custom tags in the messages are to be supported; and
d) possible values for each tag.

27. The computer system of claim 17, wherein computer code of said object includes code for causing said object to perform the functions of parsing financial transaction messages, checking tags of said messages, validating grammar of said messages, and normalizing said messages.

28. The computer system of claim 17, wherein the computer comprises:
means for reading said computer readable code so as to generate said graphical user interface; and
input means for providing said input to said computer via said graphical user interface.
